(19) United States
(12) Patent Application Publication
(10) Pub. No.: US 2014/0365280 A1
(43) Pub. Date: Dec. 11, 2014

(54) PROVISION OF FEEDBACK INFORMATION TO POINT OF SALE DEVICE OPERATORS BASED ON PERFORMANCE MEASURES

(71) Applicant: Toshiba Global Commerce Solutions Holdings Corporation, Tokyo (JP)

(72) Inventors: Vibhor Goel, Bangalore (IN); Kathiresan R. Selvaraj, Bangalore (IN)

(21) Appl. No.: 13/911,149

(22) Filed: Jun. 6, 2013

(51) Int. Cl. G06Q 10/06

(52) U.S. Cl. CPC G06Q 10/06398
USPC 705/7.42

(57) ABSTRACT

Systems and methods for provision of feedback information to point of sale device operators based on performance measures are disclosed. According to an aspect, a method includes determining an operator performance measure at a point of sale (POS) device. The method also includes generating, based on the operator performance measure, an interface for operator input. Further, the method includes receiving operator input to the interface. The method also includes providing feedback information based on the operator performance measure and the operator input.

### TECHNICAL FIELD

The present invention relates to retail equipment and systems, and more specifically, to providing feedback information to point of sale (POS) operators based on performance measures.

### BACKGROUND

In retail environments, such as grocery stores and other “brick and mortar” stores, retail personnel often operate retail equipment such as point-of-sale (POS) equipment or other computing devices. At POS equipment, for example, retail personnel may operate the equipment and interact with customers for conducting purchase transactions. Customers typically desire to conduct their purchase transactions quickly. Thus it is important for retail personnel to efficiently conduct purchase transactions for improving customer satisfaction.

Operational reports may be used by managers for understanding how a store and retail personnel are performing. For example, a report may include POS operator productivity and performance at POS equipment. For example, the report may include information such as a number of transactions conducted in a given period, a number of items or products sold, an average transactions size, and a sales amount. The manager may use information in the report for analyzing a POS operator's efficiency and productivity, and for providing suggestions for improvement to the POS operator. Such a situation can be inherently reactive. It is desired to provide improved techniques for remedying inefficiencies and a lack of productivity of POS operators. Further, it is desired to provide improved techniques for providing suggestions to POS operators for improving operator performance.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for provision of feedback information to point of sale device operators based on performance measures. According to an aspect, a method includes determining an operator performance measure at a point of sale (POS) device. The method also includes generating, based on the operator performance measure, an interface for operator input. Further, the method includes receiving operator input to the interface. The method also includes providing feedback information based on the operator performance measure and the operator input.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed.
In the drawings:

FIG. 1 is a block diagram of a system according to embodiments of the present invention;

FIG. 2 is a flowchart of an example method for implementing one or more features at a computing device in accordance with embodiments of the present invention;

FIG. 3 is a graph showing data about factors influencing ring time of operators in accordance with embodiments of the present invention;

FIG. 4 is a screen display of an example survey for an operator in accordance with embodiments of the present invention;

FIG. 5 illustrates a flow diagram showing example interaction between a customer, a POS device, and a POS device operator in accordance with embodiments of the present invention; and

FIG. 6 is a flow diagram showing example interaction between a POS device, a POS device operator, and a server in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “point of sale device” or “POS device” should be broadly construed. It can include any type of device including hardware, software, firmware, the like, and combinations thereof. A POS device may include one or more processors and memory or other suitable non-transitory, computer readable storage medium having computer readable program code for implementing methods in accordance with embodiments of the present invention. A POS device may be located within a retail environment and communicatively connected to other computing devices (e.g., POS devices or computers) for managing accounting, purchase transactions, and other processes within the retail environment. In another example, a POS device may be a mobile computing device such as, for example, but not limited to, a smart phone, a cell phone, a pager, a personal digital assistant (PDA), a mobile computer with a smart phone client, or the like that is configured for conducting purchase transactions. Although many of the examples provided herein are implemented on a POS device, the examples may similarly be implemented on any suitable computing device.

As referred to herein, the term “user interface” is generally a system by which users interact with a computing device, such as a POS device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

A POS device may be positioned where shoppers or customers move to conduct purchase transactions. The POS device may include a user interface for operation by its operator. Further, the POS device may include a display for providing customers with purchase transaction information, such as itemized purchases and prices, a total cost associated with a purchases, and related purchase transaction information. The POS device may include a processor executing software, such as a POS application. The POS device may communicate over one or more networks with entities, such as financial institutions. Purchases may be made via the POS device whereby the POS device facilitates electronic funds transfers over network(s) between customer accounts for one or more financial institutions and an establishment that implements the POS device. For this purpose, the POS device may be communicatively coupled to network(s).

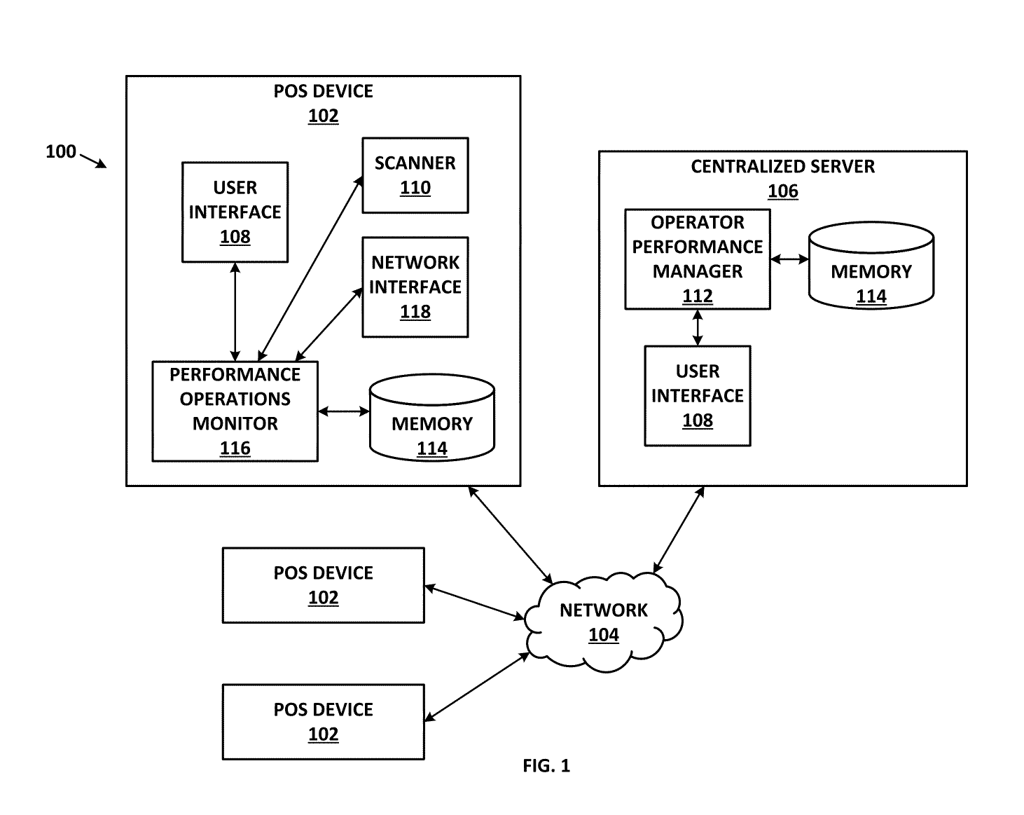

The presently disclosed invention is now described in more detail. For example, FIG. 1 illustrates a block diagram of a system 100 according to embodiments of the present invention. The system 100 may be implemented in whole or in part in any suitable environment for conducting purchase transactions. For example, the system 100 may be implemented in a retail store having a variety of products or items for purchase and one or more POS terminals. For example, a POS device 102 can be operated by retail personnel for conducting purchase transactions with customers. Multiple computing devices 102 may be communicatively connected via a communications network 104, which may be any suitable local area network (LAN), either wireless and/or wired. POS devices 102 and other components, not shown, may be configured to acquire data within the retail environment, to process the data, and to communicate the data to a centralized server 106. Further, the server 106 may communicate data to the POS devices 102 and other components of the system 100. The server 106 may reside in the retail store or be remotely located.

The components of the system 100 may each include hardware, software, firmware, or combinations thereof. For example, software residing in memory of a respective component may include instructions implemented by a processor for carrying out functions disclosed herein. As an example, POS devices 102 may each include a user interface 108 including a display (e.g., a touchscreen display), a barcode scanner, and/or other equipment for interfacing with retail personnel and for conducting a purchase transaction for purchase of items by customers. POS devices 102 may also each include memory 112. A POS device 102 may be a self-checkout POS terminal or a retail personnel-assisted POS terminal. Each POS device 102 may also include a suitable network interface 110 for communicating with the network 104. Each POS device 102 may include hardware (e.g., image capture devices, scanners, and the like) for capture of various data within the retail environment. For example, each POS device 102 may include a scanner 110 for scanning items and customer interface equipment for allowing customers to make purchases.

In accordance with embodiments of the present invention, operator performance measures may be captured at the POS devices 102. The operator performance measures may be communicated to the centralized server 106 for generating an interface for operator input and for providing feedback information based on the operator performance measure and the operator input. The feedback information can be used for assisting a POS operator with improving efficiency. Further, the feedback information can be used for providing suggestions to a POS operator for improving his or her performance.

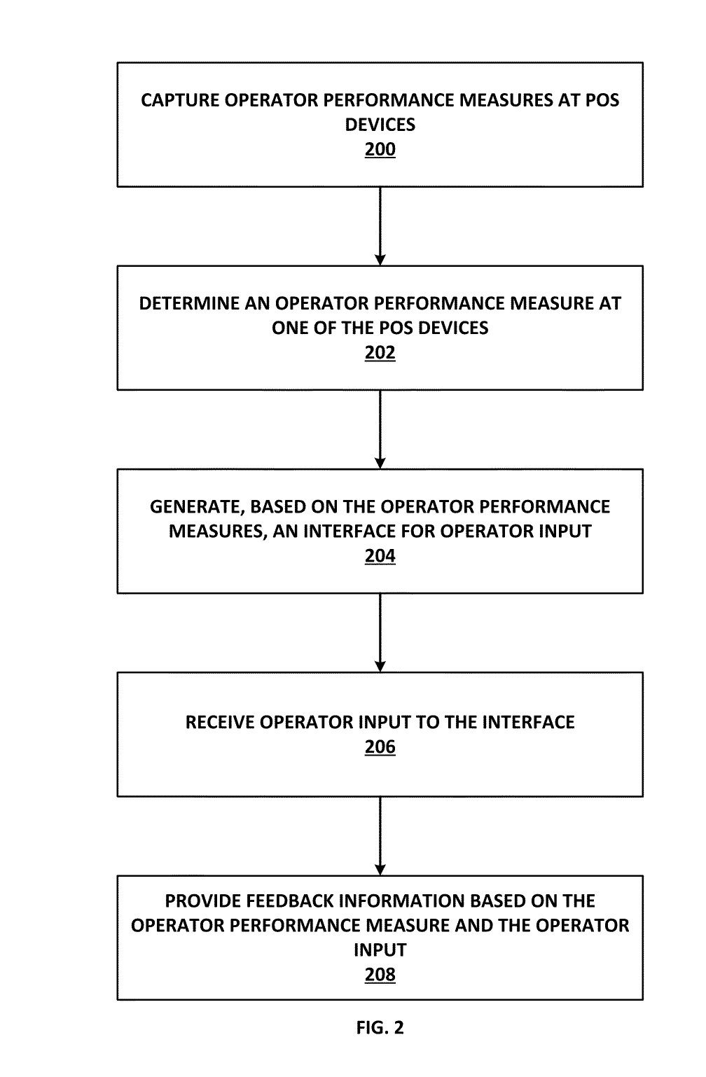

FIG. 2 illustrates a flowchart of an example method for implementing one or more features at a computing device in accordance with embodiments of the present invention. The method of FIG. 2 is described as being implemented by POS devices 102 and an operator performance manager 112 of the centralized server 106, although the method may be implemented by any suitable computing device(s). The method may be implemented by hardware, software, and/or firmware of POS devices 102, the server 106, and/or another computing device. For example, memory 114 and one or more processors (not shown) of POS devices 102 and the server 106 may implement the method.

Referring to FIG. 2, capturing 200 operator performance measures at POS devices. For example, multiple purchase transactions may be conducted at POS devices 102, and each POS device 102 may determine a number of purchase transactions conducted by the respective POS device 102 within a predetermined time period. Each POS device 102 may include a performance operations monitor 116 implemented by software, hardware, firmware, or combinations thereof and configured to count the number of purchase transactions conducted by an operator within a predetermined time period. As an example, the monitor 116 may begin counting when an operator logs onto the POS device 102 and may stop counting when the operator logs off the POS device 102. Subsequently, the monitor 116 may store the count numbers in the memory 114, and control a network interface 118 to communicate the count number to the server 106. The monitor 116 may also store in the memory 114 an identifier of the operator and an indication of the time period within which the purchase transactions were counted. The operator identifier and time period indication may be communicated to the server 106 and associated with the count number. The count number is an operator performance measure and can be indicative of a performance by the operator.

Operator performance measures may be captured based on any other suitable technique. As an example, the monitor 116 may determine a number of items or products sold, an average transaction size, a sales amount, or the like. Such measures may be stored in memory 114 and communicated to the centralized server 106. The measures may be associated with the operator logged onto the POS device 102 while the measures were captured. An identifier for the operator may be communicated to the centralized server 106.

The method of FIG. 2 includes determining 202 an operator performance measure at one of the POS devices. Continuing the aforementioned example, the centralized server 106 may receive the operator performance measures from the POS device 102 via the network 104. Further, the centralized server 106 may receive the operator identifier and the time period indication associated with each of the operator performance measures. The operator performance manager 112 may manage the handling of the operator performance measures, operator identifiers, and time period indication. For example, the manager 112 may store this data in the memory 114 at the server 106. The manager 112 may analyze this data for each operator or collectively. In this way, the server 106 may determine an operator performance measure at one or more of the POS devices.

The method of FIG. 2 includes generating 204, based on the operator performance measure, an interface for operator input. Continuing the aforementioned example, the manager 112 may generate an interface for operator input and may communicate data or information for presenting the interface at the POS device 102. The interface may be any type of data that can be interpreted by the POS device 102 and presented to the POS operator. As an example, the interface may be a questionnaire or survey that is generated particularly for the POS operator and based on one or more of the operator's performance measures. The questionnaire may include multiple statements, information, and questions. As an example, the questionnaire may provide questions and may be interactive for receipt of responses by the operator. The user interface 108 may receive responses for communication to the server 106. The data and communication in the questionnaire may be information about the operator's performance measures. The questionnaire and the operator's responses may be used by the operator and/or the operator's manager for assessing the operator's performance and for determining how to improve the operator's performance.

In an example, an operator may conduct one hundred (100) purchase transactions with customers on a particular day. In this example, the performance operations monitor 116 may be configured to monitor ring time (i.e., the time used to complete a purchase transaction) as an operator performance measure. The ring time average for the operator may be among the top 10% of operators with the highest ring time. Further, the monitor 116 may operate to collect one or more factors related to ring time. Factors related to ring time may include, but are not limited to, a number of items in a basket, time taken to scan an item, average time taken to scan items, time taken to make payment, time taken to print a receipt, and the like. The time taken to scan an item may influenced by the item not being on file, a price override scenario, an age restricted item, a manager override request, a hardware issue (e.g., a scanner has a loose connection), and the like. The time taken to make a payment may involve customer interaction and a type of tender used for making the payment. Examples that can influence the time taken to make payment may include, but are not limited to, a customer fumbles to tender change, a customer pays using multiple tenders, a credit limit reached on a credit card and customer pays by another card, customer pays by credit card and is encouraged to use a store card, a customer asks for a reg-e receipt, and the like. This information may be captured, considered as operator performance measures, and reported to the server 106. In other examples, factors may include any out of ordinary steps/requests from the customer and any out of the ordinary situations at the POS device.

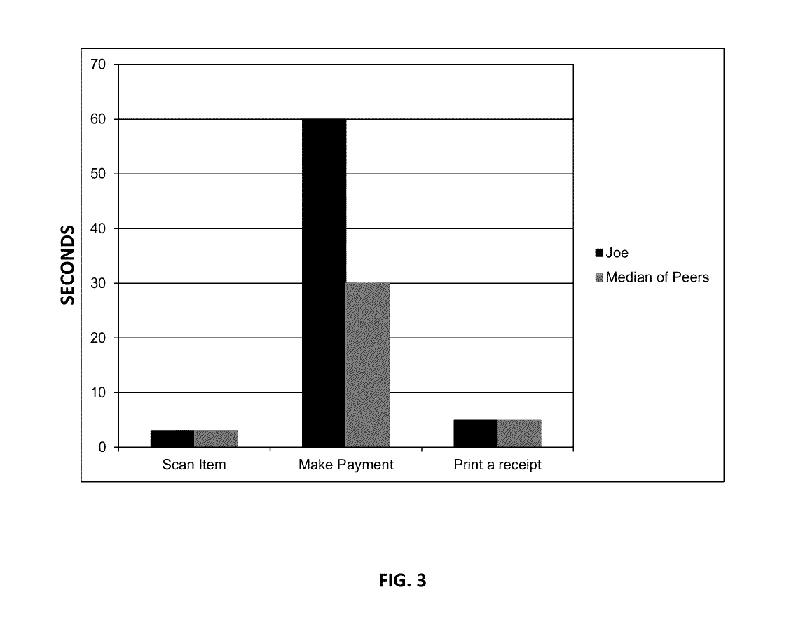

The captured operator performance measures from multiple POS devices may be collected at the centralized server 106. The manager 112 may analyze the data for generating a plausible reason that an operator is not performing as well as other operators. In the aforementioned example of the operator being among the top 10% of operators with the highest ring time, the manager 112 may compare, among the operators, factors influencing ring time such as, but not limited to, the time taken to scan items, the time taken to make payments, and the time taken to print receipts. The manager 112 may generate and present a graph or other representation of data that indicate the factors associated with the operator to the average of the other operators. Based on this representation, a conclusion may be drawn as to the reason that the ring time of the operator is high. For example, FIG. 3 illustrates a graph showing data about factors influencing ring time of operators in accordance with embodiments of the present invention. Referring to FIG. 3, the graph shows that the scan item time and the print a receipt time for an operator named “Joe” is the same as the median for peer operators. Thus, the scan item time and the print a receipt time are not likely a reason for the ring time being longer for Joe. Although, the graph of FIG. 3 also shows that the time to make payment for Joe is double that of the average for his peer operators. Therefore, it can be determined, based on this graph, is that the time to make payment is a likely explanation for the ring time being longer for Joe. Accordingly, it may be due to customer reasons that Joe cannot ring his customers out as quickly as his many of his peers.

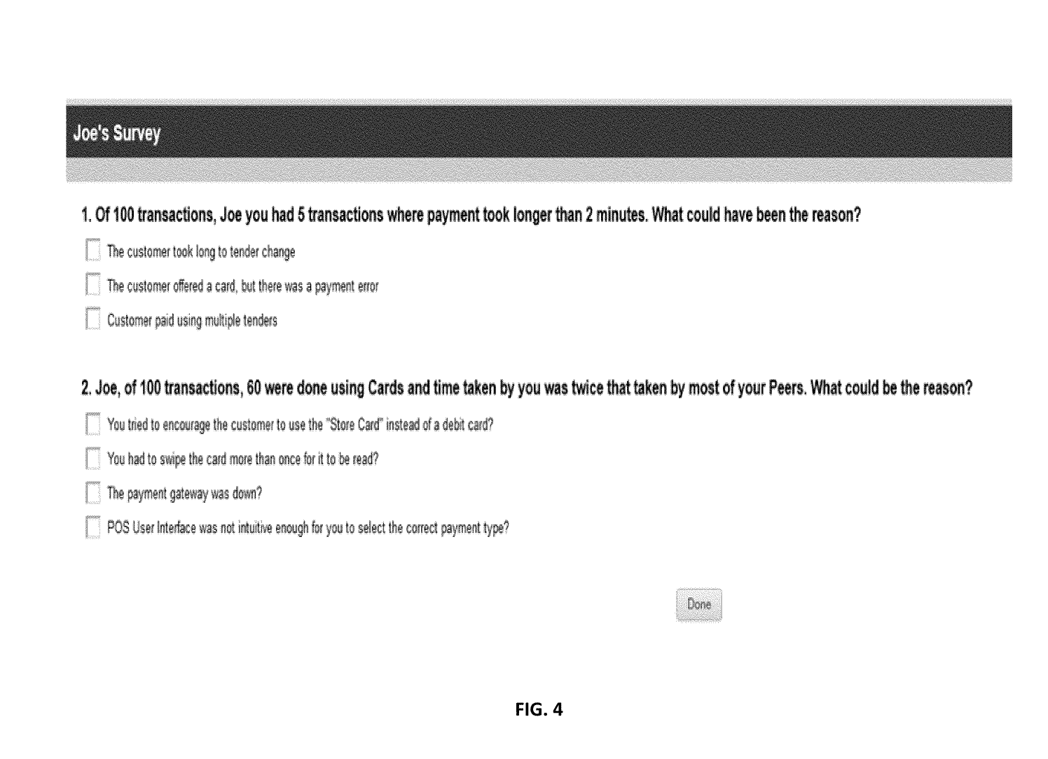

FIG. 4 illustrates a screen display of an example survey for an operator in accordance with embodiments of the present invention. The monitor 116 may display the survey using the user interface 108. The operator may interact with the survey by use of the user interface 108. Referring to FIG. 4, this screen display shows a survey for the operator named Joe discussed in the example of FIG. 3. The survey provides two questions about are provided for Joe's response. Joe may respond by checking one or more of the boxes beside an answer for the corresponding question. Once Joe has completed the survey, he may interact or “click” the “Done” box to indicate that he has completed the survey. In response to completion of the survey, the monitor 116 may communicate the entered responses to the server 106.

Returning to FIG. 2, the method includes receiving 206 operator input to the interface. Continuing the aforementioned example, questionnaire or survey information may be received at the server 106. The operator performance manager 112 may receive and manage the information. Further, the method includes providing 208 feedback information based on the operator performance measure and the operator input. For example, referring again to the survey of FIG. 4, if it is assumed that Joe answers question 2 by checking the boxes for “You had to swipe the card more than once for it to be read” and “POS User Interface was not intuitive enough for you to select the correct payment type”. In this case, the manager 112 may conclude that Joe needs more training on the payment module and user interface of his POS device. The manager 112 may present this conclusion to Joe's manager and/or communicate a message to Joe's POS device to indicate the conclusion. Subsequently, Joe may undergo more training on the payment module and the user interface.

In accordance with embodiments of the present invention, the systems and methods disclosed herein may be used for identifying retail personnel who need help. For example, the manager 112 of the centralized server 106 may receive operator performance measures from POS devices 102. The manager 112 may determine whether the operator performance measure of one or more of the POS devices 102 meets a predetermined threshold. For example, the manager 112 may determine whether the number of purchase transactions conducted by an operator within a time period. Further, the manager 112 may generate an interface for the operator in response to determining that the operator performance measure of the operator does not meet the predetermined threshold. Continuing the example, the manager 112 may generate an interface in response to determining that the number of purchase transactions is lower than a stored number. If the number of purchase transactions does not meet the stored number, it may be indicative of a problem with the operator or the operator's POS device. In this case, dialogue with the operator may be needed, or that operator input to the interface should be reviewed.

In accordance with embodiments of the present invention, a report or notice to an operator may be sent to the operator in response to determining that the operator's performance measure does not meet a criterion, such as a predetermined threshold. For example, the manager 112 may determine whether the operator performance measure meets the predetermined threshold and send a message indicating that the threshold is not met in response to the determination. The operator's POS device 102 may receive the message and present an indication via the user interface 108 to indicate that the purchase transactions do not meet the criterion. For example, the indication may be that the number of purchase transactions conducted by the operator is below the number of purchase transactions conducted by peer operators.

In accordance with embodiments of the present disclosure, a training simulation may be provided at an operator's POS device based on the operator's performance measures. As an example, an operator performance measure may indicate that the operator take too much time to conduct purchase transactions. For example, an operator performance manager, such as the manager 112 shown in FIG. 1, may determine that the average time for conducting purchase transactions for the operator is substantially greater than the time required for peer operators. Further, the manager 112 may generate a training simulation for the operator based on the operator performance measure. Further, the manager 112 may control communication of the training simulation to the operator's POS device, where it can be administered to the operator. For example, the performance operations monitor or another module may control the user interface 108 to administer the training simulation to the operator. The training simulation may be used for improving performance of the operator.

As an example of a training simulation, the manager 112 may determine that the operator often runs out of paper while conducting a purchase transaction. In this case, this may be an explanation for why the operator's time for conducting purchase transactions is high in comparison to others. For this reason, the manager may provide instructions or tips in the training simulation to teach the operator how to avoid running out of printer paper. For example, the operator may be instructed or trained to periodically check the paper level for his or her POS device. Further, for example, the operator may be instructed or trained to check the paper level when he or she has no customers waiting to conduct a purchase transaction.

In an example of implementing a training simulation, a score of the operator's performance may be maintained or tracked. For example, a POS device 102 implementing the simulation may track the operator's score.

In accordance with embodiments of the present disclosure, an operator performance manager, such as the manager 112 shown in FIG. 1, may determine that an operator performance measure does not meet a predetermined criterion. Further, the manager may determine whether a malfunction has occurred at the POS device in response to determining that the operator performance measure does not meet the predetermined criterion. For example, the manager 112 may determine that the number of purchase transactions conducted by the operator does not meet a predetermined level. A malfunction at the operator's POS device may be determined based on whether it has been a request or requirement for repair and servicing the POS device. The manager 112 may, for example, receive a report indicating that equipment of the POS device malfunctioned. In this example, the manager 112 may determine that the operator's slow time for conducting purchase transaction may have resulted from the malfunction. Thus, it may be concluded that the operator was not at fault for the slow time. The manager 112 malfunction may indicate the malfunction in a generated survey or other report for notifying a manager or operator of the malfunction.

In accordance with embodiments of the present invention, a system, such as system 100 may determine whether an activity associated with an operator of a POS device meets a predetermined criterion. In this example, the criterion may relate to activities that an operator is encouraged to perform. Example activities include, but are not limited to, sales activity with one or more customers, provision of assistance to one or more customers, and the like. In response to determining that the activity meets the predetermined criterion, the activity may be identified. For example, the manager 112 shown in FIG. 1 may determine that the operator is engaged in a sales activity. In response to this determination, the manager 112 may report the activity via the user interface 108 of the server 106.

In an example scenario, a system in accordance with embodiments of the present disclosure may capture operator performance measures of an operator as he or she operates a POS device for conducting purchase transactions. The captured performance measures of the operator may be compared to captured performance measures of other POS devices during the same time period (e.g., within one day). The POS device or a centralized server may determine that other POS devices handled many more transactions than the operator of interest. The reasons for low performance may include, but are not limited to: the operator taking longer to complete a purchase transaction; and/or customers do not visit the operator's POS device even though the operator takes about the same time to complete as purchase transaction as his or her peer operators. Further, the POS device or server may determine that the operator takes about twice as long as long to check out customers as his or her peer operators take in the same store. Example plausible reasons include, but are not limited to: the POS device malfunctioning or requiring maintenance (e.g., needed printer paper); the operator is slow; an extraordinarily high time is used for payment processing; many returns were handled by the operator; and the operator engages the customer more than others (e.g., tries to upsell or cross sell to customers). Reasons for low performance may be presented to the operator and/or a manager for helping the operator to narrow down to those reasons that are most probable. In one example, the POS device or server may determine that there were many printer-related failures for the operator's POS device. In this example, additional steps can be taken for better preventive maintenance, and the operator can be instructed with how to raise an information technology (IT) support ticket.

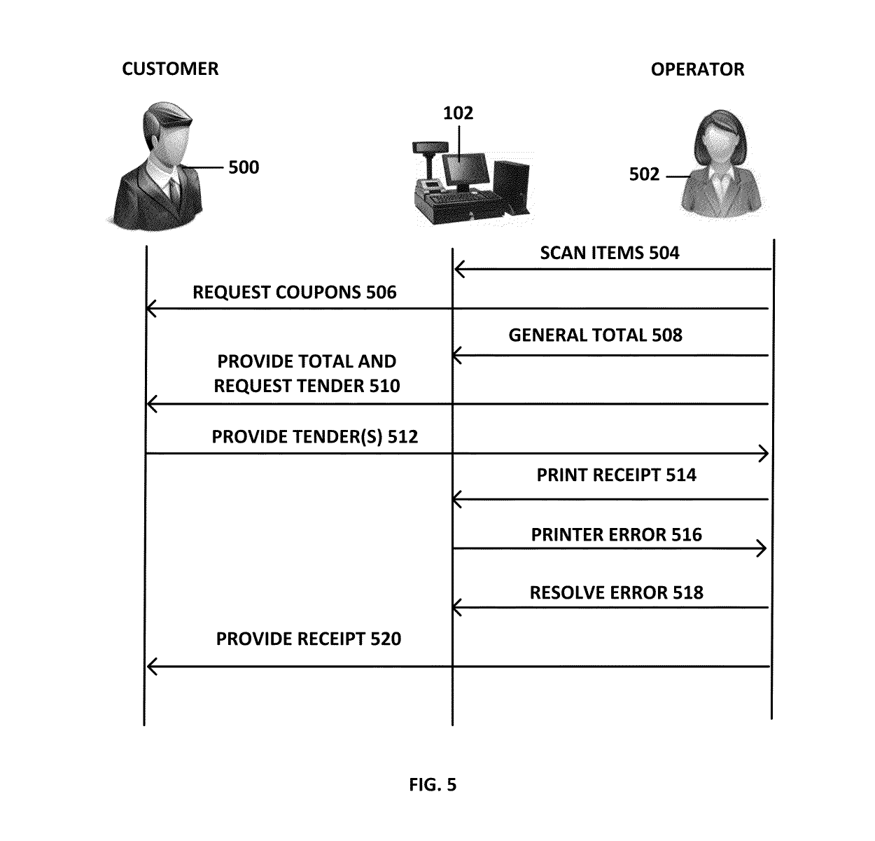

FIG. 5 illustrates a flow diagram showing example interaction between a customer 500, a POS device 102, and a POS device operator 502 in accordance with embodiments of the present invention. In this example, the POS device 102 may log or capture some or all of the steps in the customer checkout, along with time that the steps were captured. The steps may be operator performance measures. Referring to FIG. 4, the customer may go to the POS device 102 and the operator 502 may scan items with the POS device 102 (step 504). Further, the operator 502 may request coupons from the customer 500 (step 506). Subsequently, after the items are scanned and coupons (if any) are entered, a total may be generated (step 508). The total and a request for tender may be provided to the customer 500 (step 510). Next, the customer 500 may provide tender(s) (step 512), and the operator 502 may enter a command for a receipt to be printed (step 514). The printer of the POS device 102 may malfunction and generate a printer error (step 516). In response to the malfunction, the POS device 104 may store data indicative of the malfunction and associate it with the operator 502 and the operator's POS device 102. Subsequently, the operator 502 may work on the printer of the POS device 102 to resolve the malfunction (step 518). The operator 502 may then provide the receipt to the customer 500 (step 520). In this example, the malfunction may be used as a plausible reason to explain the operator's 502 performance.

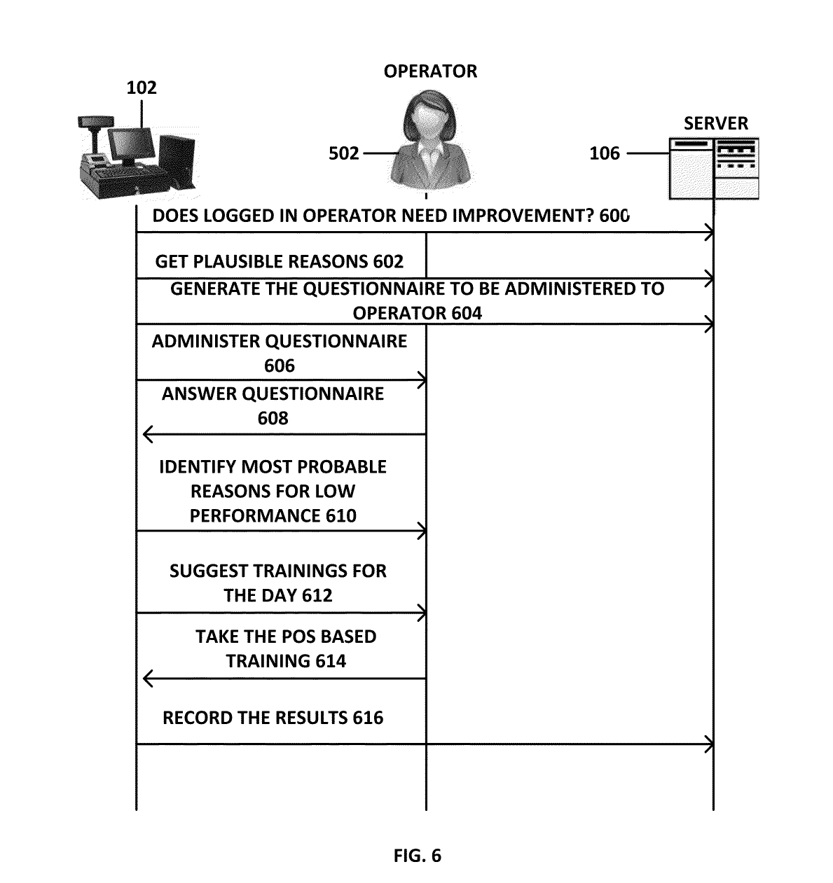

FIG. 6 illustrates a flow diagram showing example interaction between a POS device 102, a POS device operator 502, and a server 106 in accordance with embodiments of the present invention. In this example, the POS device 102 may administer a questionnaire and obtain questionnaire results. Referring to FIG. 5, the POS device 102 may determine whether a logged in operator 502 need improvement (step 600), get plausible reasons for low performance (step 602), generate the questionnaire to be administered to the operator 502 (step 604), and administer the questionnaire to the operator 502 (step 606). The operator 502 may interact with the POS device 102 to provide answers (step 608). The POS device 102 can analyze captured operator performance measures and operator answers for identifying most probable reason(s) for low performance and for providing the reasons to the operator 502 (step 610). Subsequently, the POS device 102 can suggest trainings for the day (step 612), and the operator 502 may take POS-based training by use of the POS device 102 (step 614). The results may be obtained, sent to the server 106, and recorded at the server 106 (step 616).

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
determining an operator performance measure at a point of sale (POS) device;
generating, based on the operator performance measure, an interface for operator input;
receiving operator input to the interface; and
providing feedback information based on the operator performance measure and the operator input.

2. The method of claim 1, wherein determining an operator performance measure comprises determining a number of purchase transactions conducted by the POS device within a predetermined time period.

3. The method of claim 2, further comprising:
determining whether the number of purchase transactions meet a predetermined threshold; and
in response to determining that the number of purchase transactions do not meet the predetermined threshold, generating the interface for operator input.

4. The method of claim 2, further comprising indicating, at the POS device, purchase transactions conducted at the POS device that do not meet a criterion in response to determining that the number of purchase transactions do not meet the predetermined threshold.

5. The method of claim 1, further comprises providing a training simulation at the POS device based on the operator performance measure.

6. The method of claim 5, further comprising:
administering the training simulation; and
measuring a performance level of a recipient of the training simulation.

7. The method of claim 1, further comprising:
comparing the operator performance measure to other operator performance measures at a plurality of other POS devices; and
generating the interface for operator input based on the comparison.

8. The method of claim 1, further comprising:
determining that the operator performance measure does not meet a predetermined criterion; and
in response to determining that the operator performance measure does not meet the predetermined criterion, determining whether a malfunction has occurred at the POS device.

9. The method of claim 8, further comprising indicating the malfunction in response to determining that a malfunction has occurred at the POS device.

10. The method of claim 8, wherein determining whether a malfunction has occurred at the POS device comprises determining that the POS device required one of repair and servicing.

11. The method of claim 1, further comprising:
determining whether an activity associated with an operator of the POS device meets a predetermined criterion; and
in response to determining that an activity associated with the operator of the POS device meets the predetermined criterion, identifying the activity associated with the operator.

12. The method of claim 11, wherein the activity comprises one of engagement of sales activity with one or more customers, and provision of assistance to one or more customers.

13. A system comprising:
at least one processor and memory; and
a operator performance manager configured to:
determine an operator performance measure at a point of sale (POS) device;
generate, based on the operator performance measure, an interface for operator input;
receive operator input to the interface; and
provide feedback information based on the operator performance measure and the operator input.

14. The system of claim 13, wherein the operator performance manager is configured to determine a number of purchase transactions conducted by the POS device within a predetermined time period.

15. The system of claim 14, wherein the operator performance manager is configured to:
determine whether the number of purchase transactions meet a predetermined threshold; and
generate the interface for operator input in response to determining that the number of purchase transactions do not meet the predetermined threshold.

16. The system of claim 14, wherein the POS device is configured to indicate purchase transactions conducted at the POS device that do not meet a criterion in response to determining that the number of purchase transactions do not meet the predetermined threshold.

17. The system of claim 13, wherein the POS device is configured to provide a training simulation based on the operator performance measure.

18. The system of claim 17, wherein the POS device is configured to:
administer the training simulation; and
measure a performance level of a recipient of the training simulation.

19. The system of claim 13, wherein the operator performance manager is configured to:
compare the operator performance measure to other operator performance measures at a plurality of other POS devices; and
generate the interface for operator input based on the comparison.

20. The system of claim 13, wherein the operator performance manager is configured to:
determine that the operator performance measure does not meet a predetermined criterion; and
determine whether a malfunction has occurred at the POS device in response to determining that the operator performance measure does not meet the predetermined criterion.

21. The system of claim 20, wherein the operator performance manager is configured to indicate the malfunction in response to determining that a malfunction has occurred at the POS device.

22. The system of claim 20, wherein the operator performance manager is configured to determine that the POS device required one of repair and servicing.

23. The system of claim 13, wherein the operator performance manager is configured to:
determine whether an activity associated with an operator of the POS device meets a predetermined criterion; and
identify the activity associated with the operator in response to determining that an activity associated with the operator of the POS device meets the predetermined criterion.

24. The system of claim 23, wherein the activity comprises one of engagement of sales activity with one or more customers, and provision of assistance to one or more customers.

25. A computer program product comprising:
a non-transitory computer readable storage medium having computer readable program code embodied therewith, the computer readable program code comprising:
computer readable program code configured to determine an operator performance measure at a point of sale (POS) device;
computer readable program code configured to generate, based on the operator performance measure, an interface for operator input;
computer readable program code configured to receive operator input to the interface; and
computer readable program code configured to provide feedback information based on the operator performance measure and the operator input.
